(19) United States
(12) Patent Application Publication
(10) Pub. No.: US 2025/0157460 A1
(43) Pub. Date: May 15, 2025

(54) DETECTION DEVICE, DETECTION METHOD, AND PROGRAM

(71) Applicant: NTT TechnoCross Corporation, Tokyo (JP)

(72) Inventors: Takaaki FUKUTOMI, Tokyo (JP); Kazuhira MATSUI, Tokyo (JP); Asato TANAKA, Tokyo (JP); Toshihiko TANAKA, Tokyo (JP)

(73) Assignee: NTT TechnoCross Corporation, Tokyo (JP)

(21) Appl. No.: 18/832,147

(22) PCT Filed: Jan. 25, 2022
(86) PCT No.: PCT/JP2022/002737

§ 371 Date: Jul. 23, 2024

(51) Int. Cl. G10L 15/08; G06F 16/242; G10L 15/22

(52) U.S. Cl. CPC G10L 15/08; G06F 16/243; G10L 15/22; G10L 2015/088

(57) ABSTRACT

A detection device according to an embodiment includes: a detection part configured to detect a word of interest from a result of applying speech recognition to a dialogue between a plurality of parties, based on a detection condition for the word of interest to be detected, the word of interest being a term, a word, an expression, a phrase, or a sentence that is supposed to be noticed or paid attention to; and a display information providing part configured to transmit display information to a predetermined terminal when the word of interest is detected, the display information being for displaying the detected word of interest or a display component representing the detected word of interest in a pre-registered display mode.

### TECHNICAL FIELD

The present invention relates to a detection device, a detection method, and a program.

### BACKGROUND ART

There is a technology that detects keywords during telephone calls and transmits alerts based on the number of times each keyword is used, for the purpose of improving the quality of operators' responses at call centers (also referred to as “contact centers”) and improving the efficiency of supervisors' duties such as monitoring and assisting operators' telephone calls (see, for example, patent document 1).

### CITATION LIST

### Non-Patent Document

Patent Document 1: Unexamined Japanese Patent Application Publication No. 2020-150409

### SUMMARY OF INVENTION

### Technical Problem

However, conventional technologies cannot set the conditions for keyword detection flexibly. Consequently, cases occur in which providing sufficient support for work duties such as assisting operators' telephone-answering duties or improving the efficiency of supervisors' monitoring duties is difficult.

One embodiment of the present invention has been made in view of the foregoing, and its purpose is therefore to make it possible to provide sufficient support for specific work duties.

### Solution to Problem

In order to achieve the above purpose, a detection device according to one embodiment includes: a detection part configured to detect a word of interest from a result of applying speech recognition to a dialogue between a plurality of parties, based on a detection condition for the word of interest to be detected, the word of interest being a term, a word, an expression, a phrase, or a sentence that is supposed to be noticed or paid attention to; and a display information providing part configured to transmit display information to a predetermined terminal when the word of interest is detected, the display information being for displaying the detected word of interest or a display component representing the detected word of interest in a pre-registered display mode.

### Advantageous Effects of Invention

According to the present invention, it is possible to provide support for specific work duties.

### BRIEF DESCRIPTION OF DRAWINGS

FIG. 1 is a diagram that illustrates an example overall structure of a contact center system according to an embodiment of the present invention;

FIG. 2 is a diagram that illustrates an example functional structure of a word-of-interest detection device according to the embodiment;

FIG. 3 is a flowchart that illustrates an example of a word-of-interest registration process;

FIG. 4 is a diagram that illustrates an example of a word-of-interest registration screen;

FIG. 5 is a flowchart that illustrates an example of a process of displaying a service assisting screen and an operator assisting screen;

FIG. 6 is a diagram that illustrates an example of a service assisting screen;

FIG. 7 is a diagram that illustrates an example of word-of-interest-type display;

FIG. 8 is a diagram that illustrates an example of an operator assisting screen;

FIG. 9 is a flowchart that illustrates an example of a search process in a telephone call listing screen;

FIG. 10 is a diagram that illustrates an example of a telephone call listing screen;

FIG. 11 is a diagram that illustrates a variation of the word-of-interest registration screen;

FIG. 12 is a diagram (part 1) that illustrates a variation of a detection condition setting part; and

FIG. 13 is a diagram (part 2) that illustrates a variation of a detection condition setting part.

### DESCRIPTION OF EMBODIMENTS

An embodiment of the present invention will be described below. The present embodiment will presume a contact center, and will describe a contact center system 1 that can provide support for operators and supervisors' work duties. Operators' work duties include, for example, answering telephone calls from customers. Meanwhile, supervisors' work duties include, for example, monitoring operators' telephone calls, assisting each operator in answering telephone calls, analyzing each operator's telephone calls, and so forth. However, these work duties are simply examples, and operators and supervisors may perform a variety of other work duties as well. For example, the task of analyzing each operator's telephone calls need not be performed by a supervisor and may be performed by someone else such as an analyst.

Note that, although a contact center will be described hereinafter as an example, besides a contact center, the present invention can be applied likewise to, for example, an office, to support the work duties of people working there, such as answering telephone calls, monitoring and assisting telephone calls, analyzing telephone calls, and so forth.

Also, a case will be described below, in which, when a pre-registered keyword is used during a telephone call between an operator and a customer, the use of the keyword is reported to the operator or the supervisor on a real-time basis, and in which, after the telephone call is over, a search for telephone calls in which that keyword is used is conducted for evaluation and analysis of the quality of service, and so forth. By this means, it is possible to provide support for operators' duties of answering telephone calls, supervisors' duties of monitoring and providing assistance, and, furthermore, provide support for telephone call-analyzing duties. Note that a “keyword” as used herein refers to a word, a phrase, a sentence, and the like that operators and supervisors should notice or pay attention to, and will also be referred to as a “word of interest” in the following description.

### <Overall Structure of Contact Center System 1>

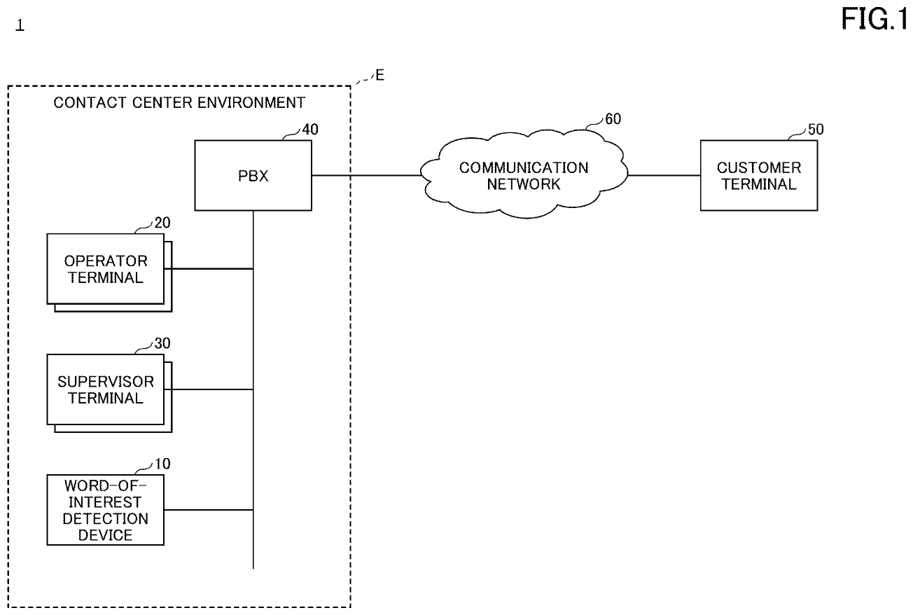

FIG. 1 shows an example overall structure of a contact center system 1 according to an embodiment of the present invention. As shown in FIG. 1, the contact center system 1 according to the present embodiment includes a word-of-interest detection device 10, one or more operator terminals 20, one or more supervisor terminals 30, a private branch exchange (PBX) 40, and a customer terminal 50. Here, the word-of-interest detection device 10, operator terminals 20, supervisor terminals 30, and PBX 40 are installed in a contact center environment E, which is the contact center's system environment. Note that the contact center environment E is by no means confined within the same building, and may be a system environment spanning a number of buildings that are geographically apart.

The word-of-interest detection device 10 converts a voice call between a customer and an operator into text by using speech recognition, detects a word of interest from this text, displays the detected word of interest on the operator terminal 20, or reports the detection of the word of interest to the supervisor terminal 30. Also, upon arrival of a search request from the supervisor terminal 30, the word-of-interest detection device 10 searches past telephone call history for telephone calls that include the word of interest, and displays the search results on the supervisor terminal 30.

The operator terminal 20 may be a variety of terminals that an operator can use, such as a personal computer (PC), and that functions as an Internet protocol (IP) telephone machine. A service assisting screen is displayed on the operator terminal 20 while a telephone call with a customer is in progress. The service assisting screen is a screen that visualizes the content of the voice call between the operator and the customer on a real-time basis, and text that is converted from the voice call by using speech recognition and words of interest detected from the text are visualized thereon.

The supervisor terminal 30 may be a variety of terminals that a supervisor can use, such as a PC. Note that a supervisor is a person who monitors the operators' telephone calls and assists the operators in answering telephone calls when a problem arises or upon request from the operators. Normally, one supervisor monitors the telephone calls of several operators to several tens of operators.

The supervisor terminal 30 displays an operator assisting screen, a telephone call listing screen, and the like. The operator assisting screen is a screen for monitoring and assisting the operators' telephone calls, and, when a word of interest is detected in an operator's telephone call, a report to that effect is sent. Also, the telephone call listing screen is a screen for searching for telephone calls for analysis such as service quality evaluation. For example, by specifying a word of interest as a search condition, a list of telephone calls including that word of interest is displayed on the telephone call listing screen.

The PBX 40 is a telephone exchange (IP-PBX) and is connected to a communication network 60 such as a voice over Internet protocol (VoIP) network and a public switched telephone network (PSTN). When a call arrives from a customer terminal 50, the PBX 40 calls up one or more predetermined operator terminals 20 and connects the customer terminal 50 with one operator terminal 20 that answers the call.

The customer terminal 50 may be a variety of terminals that a customer can use, such as a smartphone, a mobile phone, a fixed-line telephone, and so forth.

Note that the overall structure of the contact center system 1 shown in FIG. 1 is an example, and other structures may be applicable as well. For example, although the word-of-interest detection device 10 is included in the contact center environment E (in other words, the word-of-interest detection device 10 is an on-premises type) in the example shown in FIG. 1, all or part of the functions of the word-of-interest detection device 10 may be implemented by a cloud service or the like. Similarly, although the PBX 40 is an on-premises telephone exchange in the example shown in FIG. 1, it may be implemented by a cloud service as well.

### <Functional Structure of Word-Of-Interest Detection Device 10>

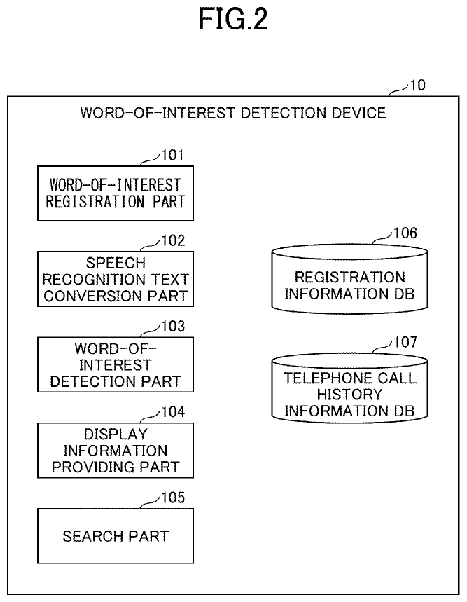

FIG. 2 shows a functional structure of the word-of-interest detection device 10 according to the present embodiment. As shown in FIG. 2, the word-of-interest detection device 10 according to the present embodiment includes a word-of-interest registration part 101, a speech recognition text conversion part 102, a word-of-interest detection part 103, a display information providing part 104, and a search part 105. These parts are implemented, for example, by one or more programs that are installed in the knowledge search device 10 and cause a processor such as a central processing unit (CPU) to execute processes.

Also, the word-of-interest detection device 10 according to the present embodiment includes a registration information DB 106 and a telephone call history information DB 107. Each DB (database) is implemented by, for example, a secondary storage device such as a hard disk drive (HDD) or a solid state drive (SSD). Note that at least one of these DBs may be implemented by, for example, a database server or the like connected to the word-of-interest detection device 10 via a communication network.

The word-of-interest registration part 101 stores registration information, including the word-of-interest detection condition and the like, in the registration information DB 106 upon arrival of a registration request from the supervisor terminal 30. By this means, the word-of-interest detection condition, and so forth are registered with the word-of-interest detection device 10.

The speech recognition text conversion part 102 converts a voice call between the operator terminal 20 and the customer terminal 50 into text by using speech recognition. In this case, the speech recognition text conversion part 102 applies speech recognition to each speaker and converts his/her speech into text. By this means, the operator's voice and the customer's voice are both converted into text.

The word-of-interest detection part 103 detects words of interest in the text produced by the speech recognition text conversion part 102, based on the detection condition in the registration information stored in the registration information DB 106.

The display information providing part 104 transmits information (hereinafter also referred to as “display information”) for allowing the operator terminal 20 and the supervisor terminal 30 to display various screens (including the service assisting screen, operator assisting screen, telephone call listing screen, etc.).

Upon arrival of a search request from the supervisor terminal 30, the search part 105 searches the telephone call history information DB 107 for telephone call history information that matches the search conditions.

The registration information DB 106 stores registration information. The registration information refers to information that includes at least the detection condition for detecting words of interest. As will be described below, the registration information includes various information set by the supervisor on a word-of-interest registration screen (including, for example, domains subject to detection of words of interest, the types and names of the words of interest, icons and colors that represent the words of interest, the screen that will be displayed when the words of interest are detected, etc.).

The telephone call history information DB 107 stores telephone call history information. The telephone call history information refers to information that represents the contents of past telephone calls. For example, for each past telephone call, the telephone call ID, the date and time of the telephone call (the date and time the telephone call started and the date and time the telephone call ended), information about the operator who answered the telephone call (the operator's ID, name, domain, etc.), the operator's extension number, the customer's telephone number, the text produced by the speech recognition text conversion part 102, information about the words of interest in the text, and so forth are included in the telephone call history information. Here, information about a word of interest refers to, for example, a word of interest and information that is necessary to display that word of interest on various screens (for example, information that specifies the mode of display, such as the color and type of an icon that is used when the word of interest is displayed).

Note that operators belong to at least one domain, and the content of their responses generally varies depending on what domain they belong to. Typical examples of domains include “contract,” “maintenance,” “service guidance,” and so forth. Operators belonging to “contract” are responsible for answering inquiries about contracts. Operators belonging to “maintenance” are responsible for answering inquiries about maintenance such as troubleshooting. Operators belonging to “service guidance” are responsible for answering inquiries that involve guidance, such as guidance on service contents.

### <Word-Of-Interest Registration Process>

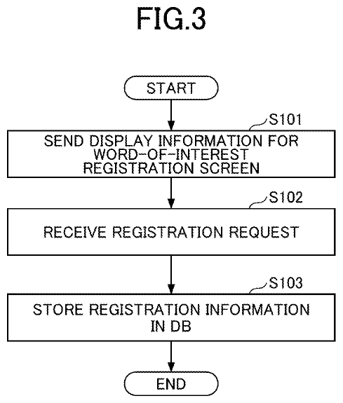

The process of registering a word of interest will be described below with reference to FIG. 3.

The display information providing part 104 of the word-of-interest detection device 10 transmits display information for a word-of-interest registration screen to the supervisor terminal 30 upon arrival of a display request from the supervisor terminal 30 (step S101). By this means, a screen for registering a word of interest is displayed on the display of the supervisor terminal 30.

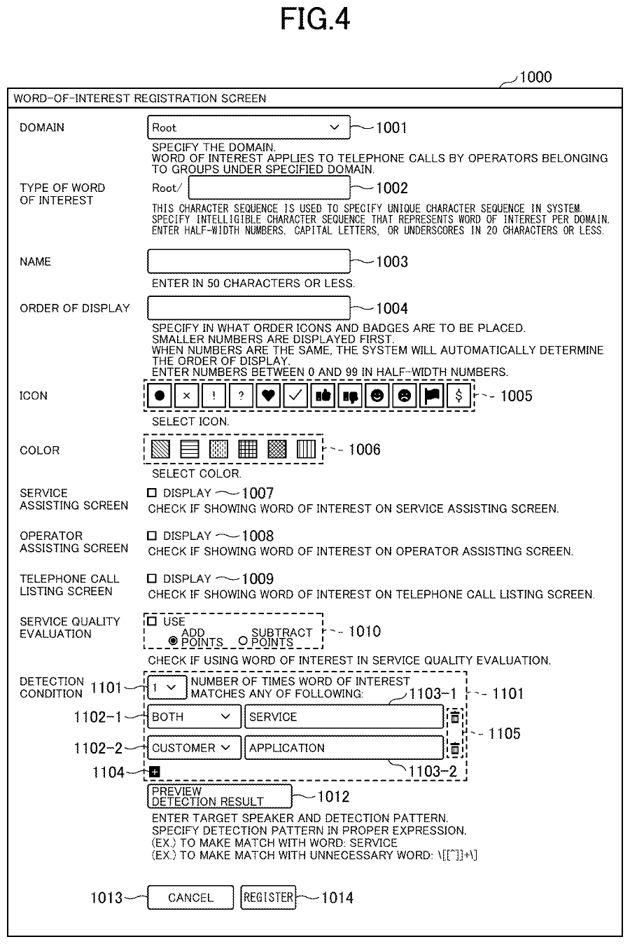

Here, an example of the word-of-interest registration screen is shown in FIG. 4. The word-of-interest registration screen 1000 shown in FIG. 4 includes a domain setting part 1001, a word-of-interest-type setting part 1002, a name setting part 1003, a display order setting part 1004, an icon setting part 1005, a color setting part 1006, a service assisting screen display ON/OFF setting part 1007, an operator assisting screen display ON/OFF setting part 1008, a telephone call listing screen display ON/OFF setting part 1009, a service quality evaluation ON/OFF setting screen 1010, a detection condition setting part 1011, a preview display button 1012, a cancel button 1013, and a register button 1014.

The domain setting part 1001 is a part in which the domain that is subject to detection of a word of interest is set. Telephone calls made by operators belonging to the domain set in the domain setting part 1001 are subject to detection of the word of interest. Note that, if “Root” is set, all domains are subject to detection of the word of interest.

The word-of-interest-type setting part 1002 is a part in which a character sequence (word-of-interest-type) that uniquely identifies the word of interest for the domain set in the domain setting part 1001 is set. Although any character sequence can be set in the word-of-interest-type setting part 1002, for example, “NG,” which indicates that the word of interest is inappropriate for the domain, “◯◯ service,” which indicates that the word of interest relates to a certain specific service in the domain, and the like may be set. By this means, unique words of interest can be specified by using “domain/character sequence” such as “Root/NG,” “Root/◯◯ service,” and so forth. This is because there are words of interest that are common to all domains, and there are also domain-specific words of interest. Note that, below, “Root” may be simply shown as “R,” and, accordingly, “Root/NG” may be simply written as “R/NG.”

The name setting part 1003 is a part in which any name may be set for the word of interest. The display order setting part 1004 is a part in which the order in which icons related to the word of interest are displayed side by side on the operator assisting screen, which will be described later, is set. The icon setting part 1005 is a part in which the icons to be displayed on the operator assisting screen, which will be described later, are set. Note that the icons are not only selected and set from predetermined ones. For example, arbitrary image data or the like may be uploaded, and that image may be set as an icon.

The color setting part 1006 is a part in which the color for displaying the word of interest with emphasis, on a service assisting screen or the like, which will be described later, when the word of interest is detected, is set. Note that the color need not be selected and set from predetermined colors, and any color may be set, for example, by using color codes or the like.

The service assisting screen display ON/OFF setting part 1007 is a part in which whether or not to display the word of interest with emphasis on the service assisting screen when the word of interest is detected is set. The operator assisting screen display ON/OFF setting part 1008 is a part in which whether or not to display whether the word of interest is detected or not on the operator assisting screen is set. The telephone call listing screen display ON/OFF setting part 1009 is a part in which whether or not to display the word of interest on the telephone call listing screen when the word of interest is detected is set.

The service quality evaluation ON/OFF setting screen 1010 is a part in which whether or not to use the detection results of the word of interest in analyzing service quality evaluation, and, when the detection results of the word of interest are so used, whether points are added or points are subtracted every time the word of interest is detected, are set.

The detection condition setting part 1011 is a part in which the word of interest and its detection condition are recorded, and includes a matching count setting part 1101, one or more speaker setting parts 1102, and one or more detection pattern setting parts 1103. Here, the speaker setting parts 1102 and detection pattern setting parts 1103 can be added or removed. That is, new speaker setting parts 1102 and detection pattern setting parts 1103 are added by pressing an add button 1104, and removed by pressing remove buttons 1105 that correspond to the new speaker setting parts 1102 and detection pattern setting parts 1103. In the example shown in FIG. 4, two rows of speaker setting parts 1102 and detection pattern setting parts 1103 are displayed: a speaker setting part 1102-1 and a detection pattern setting part 1103-1, and a speaker setting part 1102-2 and a detection pattern setting part 1103-2.

The matching count setting part 1101 is a part in which the number of matchings is set. The speaker setting part 1102 is a part in which the speaker of the word of interest is set. Note that the speaker can be set to either “operator,” which is the operator, “customer,” which is the customer, or “both,” which is both the operator and the customer. The detection pattern setting part 1103 is a part in which the word of interest is set. Here, in the detection pattern setting part 1103, a character sequence that represents the word of interest can be set as is, or the word of interest can be set by using its regular expression. By setting the word of interest by using its regular expression, for example, it is possible to set a group of words of interest, such as words of interest that are similar to each other or words of interest that are different from each other only in part.

For example, when the matching count setting part 1101 is set to “1,” the speaker setting part 1102 is set to “customer,” and the detection pattern setting part 1103 is set to “application,” if the customer says “apply” once during a telephone call, the word of interest “apply” is detected.

Also, for example, when the matching count setting part 1101 is set to “3,” the speaker setting part 1102 is set to “operator,” and the detection pattern setting part 1103 is set to “AAA service,” if the operator says “AAA service” three times during a telephone call, the word of interest “AAA service” is detected. Note that, in this case, “AAA service” is not detected as a word of interest if the operator says “AAA service” only twice.

The preview display button 1012 is a button for displaying a preview of the service assisting screen, operator assisting screen, and telephone call listing screen when the word of interest is detected. A cancel button 1013 is a button for canceling the registration of the word of interest. The register button 1014 is a button for registering the information set on the word-of-interest registration screen 1000. When the supervisor presses the register button 1014, a registration request including the information set from the domain setting part 1001 to the detection condition setting part 1011 is sent from the supervisor terminal 30 to the word-of-interest detection device 10.

Referring back to FIG. 3, the word-of-interest registration part 101 of the word-of-interest detection device 10 receives a registration request from the supervisor terminal 30 (step S102).

Then, the word-of-interest registration part 101 of the word-of-interest detection device 10 prepares registration information from the registration request, and stores the created registration information in the registration information DB 106 (step S103). Note that the word-of-interest registration part 101 may prepare, for example, registration information that includes a registration information ID and the information included in the registration request.

### <Service Assisting Screen and Operator Assisting Screen Display Process>

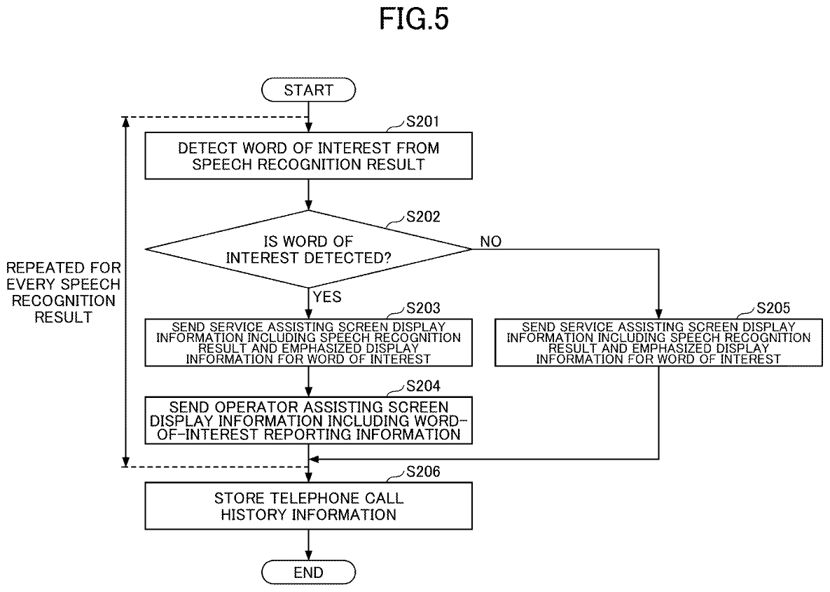

The process of displaying the service assisting screen and operator assisting screen will be described below with reference to FIG. 5. Note that the service assisting screen is displayed on the operator terminal 20 display during a telephone call with a customer. The operator assisting screen is displayed on the display of the supervisor terminal 30 during work. The following description will assume a case in which a certain operator and a certain customer are talking on the phone, and the process of displaying the service assisting screen that is displayed on the operator terminal 20 used by this operator and the operator assisting screen that is displayed on the supervisor terminal 30 used by the supervisor who monitors and assists this operator will be described. Also, voice per segment in speech (for example, a sentence, a phrase, etc.) is converted to text by the speech recognition text conversion part 102. It is assumed that the following steps S201 to S206 are repeated every time a segment's speech recognition result is obtained.

The word-of-interest detection part 103 of the word-of-interest detection device 10 uses the detection condition that pertains to the domain to which the operator belongs, included in the registration information stored in the registration information DB 106, to detect the words of interest from the text the call is converted into by speech recognition (step S201). Note that, as mentioned earlier, a detection condition such as the number of matchings, the speaker, the detection pattern, and the like may be used. If the speaker says the word of interest represented by the detection pattern a number of times greater than or equal to the number of matchings during the telephone call, the word of interest is detected.

The word-of-interest detection part 103 of the word-of-interest detection device 10 determines whether the word of interest was detected in step S201 (step S202).

If it is determined that the word of interest was detected in step S202, the display information providing part 104 of the word-of-interest detection device 10 transmits display information to the operator terminal 20. This display information includes text that represents the result of speech recognition and emphasized display information for displaying the word of interest detected in step S201 with emphasis by using the color set in the color setting part 1006 when this word of interest was registered (step S203). By this means, on the service assisting screen of the operator terminal 20, the text is displayed and the words of interest in the text are shown with emphasis.

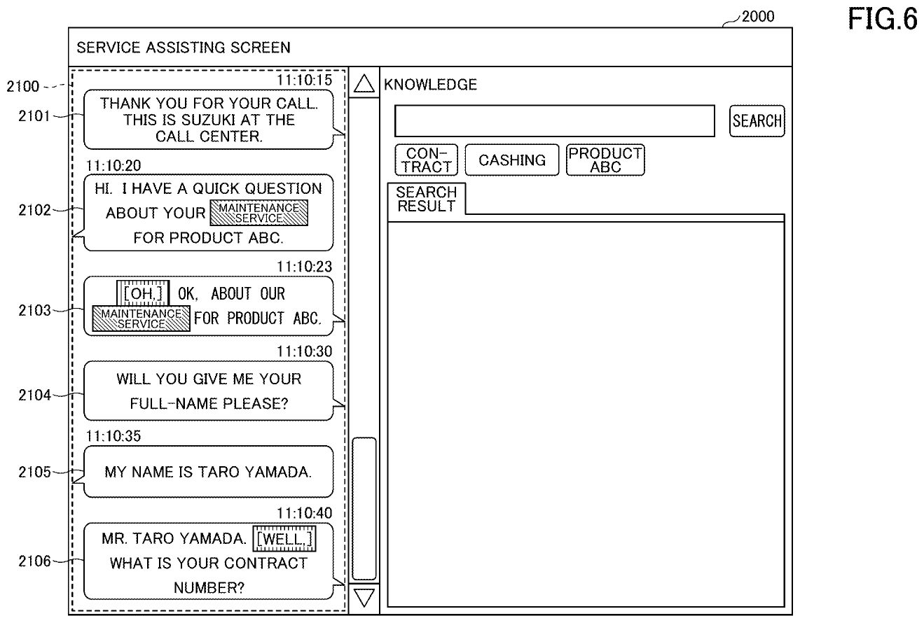

Here, an example of the service assisting screen is shown in FIG. 6. The service assisting screen 2000 shown in FIG. 6 includes a talk history part 2100 in which texts representing the speech recognition results are displayed in chronological order in real time. In the example shown in FIG. 6, a talk history part 2100 displays talk texts 2101 to 2106. These talk texts 2101 to 2106 represent results of speech recognition and are displayed in chronological order. Note that a filler such as “Oh” is displayed in parentheses in the talk history part 2100.

Also, in the example shown in FIG. 6, “maintenance service” in the talk text 2102 is shown with emphasis. This means that the word of interest “maintenance service” has been detected in this talk text 2102.

Similarly, “Oh” and “maintenance service” in the talk text 2103 are shown with emphasis. This means that “Oh” and “maintenance service” in this talk text 2103 were detected as words of interest. Note that “Oh” and “maintenance service” are different words of interest; different colors are set for these words and so they are shown with emphasis in different colors.

Similarly, “Oh” in the talk text 2106 is shown with emphasis. This also means that “Oh” in this talk text 2106 is detected as a word of interest.

By this means, the operator can visually confirm words of interest (for example, terms, words, expressions, phrases, sentences, and the like that are supposed to be noticed or paid attention to) with ease, on a real-time basis, when they are detected. Furthermore, each word of interest is shown with emphasis in a different color. One can tell what type of word of interest he/she is looking at from its color (for example, a word of interest shown with emphasis in red is an “NG” word). Therefore, the operator can, for example, focus only on words of interest that he/she really needs to pay attention to, thereby checking words of interest more efficiently.

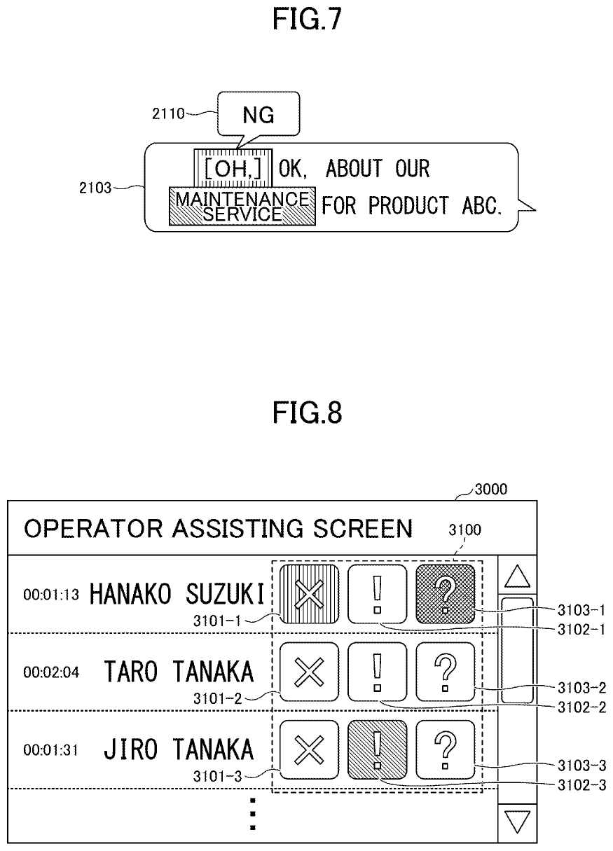

Note that, for example, when a pointer or like is placed over a shown with emphasis word of interest, the word-of-interest-type set in the word-of-interest-type setting part 1002 or the name set in the name setting part 1003 when registering the word of interest may be shown. For example, as shown in FIG. 7, when a pointer or the like is placed over “Oh” in the talk text 2103, a speech bubble 2110 containing “NG,” which shows the type or name of the word of interest “Oh,” is shown.

Referring back to FIG. 5, following step S203, the display information providing part 104 of the word-of-interest detection device 10 transmits display information, including word-of-interest reporting information, to the supervisor terminal 30 (step S204). Note that the word-of-interest reporting information is information for reporting detection of the word of interest. By this means, detection of the word of interest is reported on the operator assisting screen of the supervisor terminal 30.

Here, an example of the operator assisting screen is shown in FIG. 8. The operator assisting screen 3000 shown in FIG. 8 includes a report display part 3100, in which, when a word of interest is detected during a telephone call by an operator being monitored and assisted by a supervisor, the detection of the word of interest is reported. In the example shown in FIG. 8, “Hanako Suzuki,” “Taro Tanaka,” and “Jiro Tanaka” are operators being monitored and assisted, and icons 3101 to 3103 representing words of interest are shown with respect to each of them. That is, icons 3101-1 to 3103-1 are shown for “Hanako Suzuki,” icons 3101-2 to 3103-2 are shown for “Taro Tanaka,” and icons 3101-3 to 3103-3 are shown for “Jiro Tanaka.” These icons 3101 to 3103 are set in the icon setting part 1005 when words of interest are registered.

Then, on the operator assisting screen 3000, when a word of interest is detected, an icon corresponding to this word of interest is shown with emphasis. For example, in the example shown in FIG. 8, the icon 3101-1 and the icon 3103-1 are shown with emphasis. This means that a word of interest that corresponds to the icon 3101 and a word of interest that corresponds to the icon 3103 were detected in a telephone call by the operator “Hanako Suzuki.” Similarly, in the example shown in FIG. 8, the icon 3102-2 is shown with emphasis. This means that a word of interest corresponding to the icon 3102 is detected in a telephone call by the operator “Jiro Tanaka.”

By this means, when a word of interest is detected, the supervisor can visually check the word of interest, with ease, on a real-time basis. Moreover, since the icon corresponding to the word of interest is shown with emphasis, the supervisor can easily know, from the icon, what kind of word of interest is detected. Therefore, the operator can, for example, focus only on words of interest that he/she really needs to pay attention to, thereby checking words of interest more efficiently.

Note that, by selecting an operator's name on the operator assisting screen, the supervisor can display a screen that is similar to that operator's service assisting screen, on the supervisor terminal 30. By this means, when a word of interest is detected, it is possible to check the content of the telephone call where the word of interest is detected, and provide support such as preventing trouble, giving advice to the operator, and so forth.

Referring back to FIG. 5, if it is determined in step S202 above that no word of interest is detected, the display information providing part 104 of the word-of-interest detection device 10 transmits display information, including text that represents the result of speech recognition, to the operator terminal 20 (step S205). By this means, the text is displayed on the service assisting screen of the operator terminal 20.

When the telephone call ends, the word-of-interest detection part 103 of the word-of-interest detection device 10 prepares telephone call history information, which at least includes the text produced by the speech recognition text conversion part 102 from the voices of the telephone call, and information about the words of interest in the telephone call, and stores the telephone call history information prepared thus, in the telephone call history information DB 107 (step S206). Note that the telephone call history information may include, besides information about the text and words of interest, for example, the telephone call's ID, the telephone call's date and time (the date and time the telephone call started, and the date and time the telephone call ended), information about the operator who answered the telephone call (the operator's ID, name, domain, etc.), the operator's extension number, and the customer's telephone number. Also, information about a word of interest includes not only the word of interest, but also includes information such as the color that is used when displaying the word of interest with emphasis, the type of the icon that represents the word of interest, and so forth. By this means, for example, after the telephone call ends, the telephone call history information can be used to analyze service quality evaluation, and the like.

### <Search Process in Telephone Call Listing Screen>

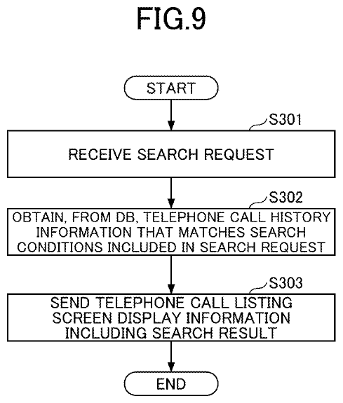

Hereinafter, the search process in the telephone call listing screen will be described with reference to FIG. 9.

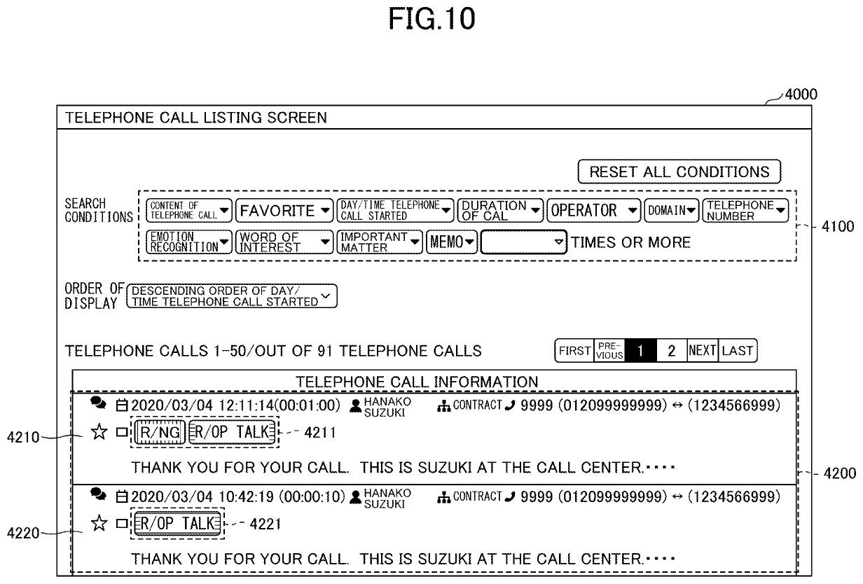

The search part 105 of the word-of-interest detection device 10 receives a search request from the supervisor terminal 30 (step S301). Here, the supervisor terminal 30 can specify search conditions on the telephone call listing screen, and transmit a search request including the search conditions specified, to the word-of-interest detection device 10. For example, when the telephone call listing screen 4000 shown in FIG. 10 is displayed on the supervisor terminal 30, the supervisor can specify the desired search conditions via the search condition specifying part 4100.

In the search condition specifying part 4100 of the telephone call listing screen 4000 shown in FIG. 10, a variety of search conditions such as “content of call,” “favorite,” “date and time call started,” “operator,” “domain,” “telephone number,” “emotion recognition,” “word of interest,” “important matter,” “memo,” and so forth can be specified. For example, in “operator,” the operator's name, ID, and so forth can be specified as search conditions. Similarly, in “domain,” the domain's name, ID, and so forth can be specified as search conditions, and, in “telephone number,” the telephone number can be specified as a search condition. Also, for example, in “word of interest,” a word of interest or a regular expression representing that word of interest can be specified as a search condition. Furthermore, when a word of interest or a regular expression representing that word of interest is specified as a search condition in the search condition specifying part 4100, the number of occurrences of the word of interest during a telephone call can be further specified as a search condition. By this means, for example, it is possible to search for “a telephone call in which a certain word of interest was detected once or more,” “a telephone call in which a certain word of interest was detected twice or more,” and so forth.

Note that the present invention is by no means limited to specifying only one word of interest, and multiple words of interest can be specified as search conditions. Also, different search conditions can be combined as appropriate (for example, a search condition that combines “word of interest” and “domain” can be specified).

Referring back to FIG. 9, the search part 105 of the word-of-interest detection device 10 searches the telephone call history information DB 107 for telephone call history information that matches the search conditions included in the search request from the supervisor terminal 30 (step S302). For example, if the word of interest “◯◯ service” and the number of occurrences “2 times or more” are specified as search conditions, the search part 105 searches the telephone call history information DB 107 for telephone call history information of telephone calls in which the word of interest “◯◯ service” was detected twice or more.

Then, the display information providing part 104 of the word-of-interest detection device 10 transmits display information, including the telephone call history information obtained in step S302, to the supervisor terminal 30 (step S303). By this means, the telephone calls obtained as search results are displayed in a list on the telephone call listing screen on the supervisor terminal 30. For example, the telephone call information display part 4200 on the telephone call listing screen 4000 in FIG. 10 displays telephone call history information 4210 and telephone call history information 4220, obtained in step S302.

Also, at this time, in the telephone call history information 4210, the type of the word of interest detected in the telephone call corresponding to the telephone call history information 4210 is displayed in the word-of-interest display part 4211. Similarly, in telephone call history information 4220, the type of the word of interest detected in the telephone call corresponding to telephone call history information 4220 is displayed in the word-of-interest display part 4221. By this means, the supervisors can easily see which words of interest were detected in which telephone calls. Therefore, for example, when an analysis of service quality evaluation and the like is conducted from the viewpoint of whether or not a word of interest is detected, telephone call history information that includes the target word of interest can be found with ease.

Note that, although the word-of-interest display part shows display components of “domain/type of word of interest,” such as “R/NG” and “R/OP talk,” the number of times searches have been made using the word of interest may be added to this. That is, for example, a display component such as “domain/type of word of interest/number of searches” may be displayed. By this means, the supervisor can see how many times searches have been made using the word of interest up until then.

### SUMMARY

As described above, the word-of-interest detection device 10 according to the present embodiment makes it possible to set, for each domain, a word of interest by using its regular expression, its speaker, the number of times the word of interest occurs during a telephone call, and so forth as a detection condition. It is also possible to set the color, icon, and the like that are used when the word of interest is detected and displayed with emphasis. In this way, it is possible to flexibly set the conditions for detection of a word of interest and the display mode when the word of interest is detected. Therefore, even when the telephone answering duties, monitoring/assisting duties, analysis duties and so forth vary from domain to domain, it is still possible to set an appropriate detection condition and a display mode that are suitable for each domain.

Furthermore, because it is possible to set a word of interest by using its regular expression or set similar or related words of interest at the same time, it is also possible to reduce the cost of work required for registering words of interest.

### <Variations>

Hereinafter, variations of the present embodiment will be described. Note that the following variations can be combined as appropriate.

### <<Variation 1>>

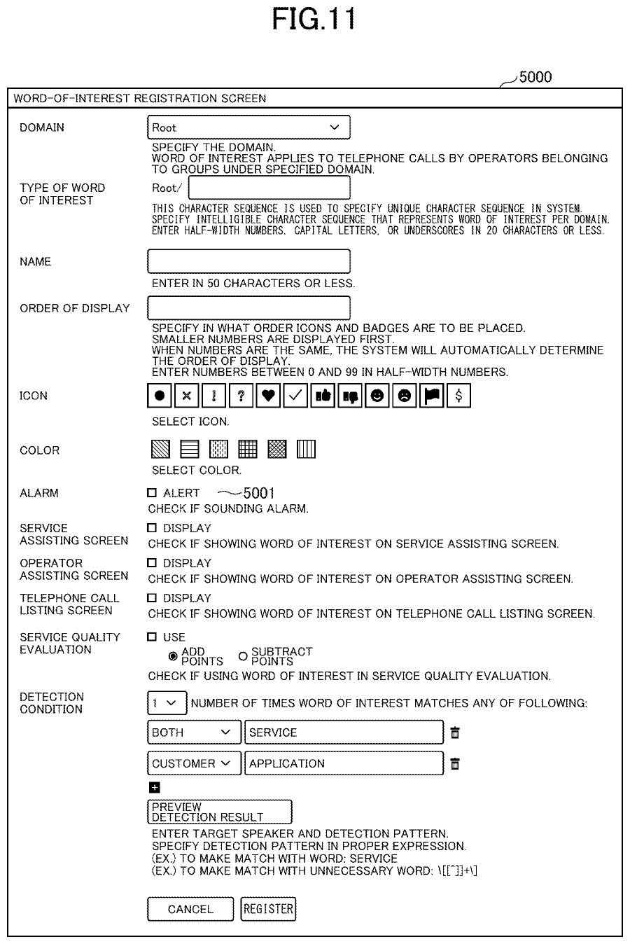

Whether or not to sound an alarm on the operator assisting screen when a word of interest is detected may be set on word-of-interest registration screen. In this case, for example, an alarm notification setting part 5001 may be included, as in the word-of-interest registration screen 5000 shown in FIG. 11.

On the operator assisting screen, a predetermined alarm sound is produced when a word of interest that sounds an alarm is detected. The supervisor can hear the sound when the word of interest is detected.

The alarm sound that is produced when a word of interest is detected may be selected from predetermined sounds, or music data may be uploaded and used as the alarm sound. Also, an alarm may be produced only when a word of particularly high importance is detected.

### <<Variation 2>>

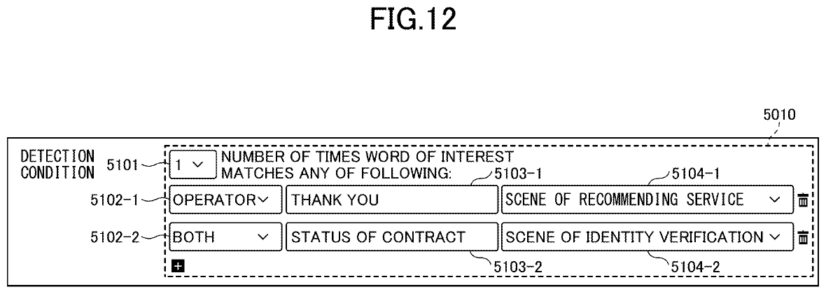

The scene that is subject to word-of-interest detection may be set in the detection condition setting part of the word-of-interest registration screen. For example, as shown in FIG. 12, the detection condition setting part 5010 may include a matching count setting part 5101, one or more speaker setting parts 5102, detection pattern setting parts 5103, and scene setting parts 5104. Here, a “scene” refers to the situation in which a dialogue takes place between an operator and a customer. Typical scenes include, for example, an “opening scene,” in which the first greetings and pleasantries are exchanged, a “question understanding scene,” in which the content of the customer's inquiry is understood, an “answering scene,” in which the inquiry is answered or accommodated, an “identity verification scene,” in which verification of identity or the like is performed, a “service recommendation scene,” in which some kind of service is recommended, and a “closing scene,” in which final greetings and pleasantries are exchanged. Note that scenes can be identified by using existing technologies (see, for example, the technology disclosed in International Publication No. 2020/036189).

In the example shown in FIG. 12, “1” is set in the matching count setting part 5101, “operator” is set in the speaker setting part 5102-1, “thank you” is set in the detection pattern setting parts 5103-1, and “service recommendation scene” is set in the scene setting parts 5104-1. This means that if the operator says “thank you” once in a service recommendation scene in a telephone call, the word of interest “thank you” is detected.

Similarly, in the example shown in FIG. 12, “1” is set in the matching count setting part 5101, “both” is set in the speaker setting part 5102-2, “contract status” is set in the detection pattern setting parts 5103-2, and “identity verification scene” is set in the scene setting parts 5104-2. This means that, if the operator and the customer both say “contract status” once in the identity verification scene during a telephone call, the word of interest “contract status” is detected.

By this means, a word of interest that is set in the detection pattern setting part is prevented from being detected in scenes other than the target scene for word-of-interest detection. For example, in the example shown in FIG. 12, with respect to the operator saying “thank you” in a scene other than a service recommendation scene (for example, in the opening scene), “thank you” can be prevented from being detected as a word of interest. Therefore, for example, settings can be arranged such that a word that is frequently used throughout a telephone call but is used rarely in a particular scene, is detected as a word of interest.

### <<Variation 3>>

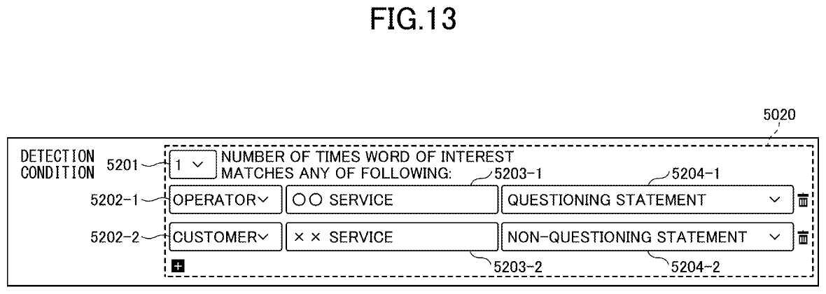

The type of statement (a questioning statement or a non-questioning statement) that is subject to word-of-interest detection may be set in the detection condition setting part of the word-of-interest registration screen. For example, as shown in FIG. 13, the detection condition setting part 5020 may include a matching count setting part 5201, one or more speaker setting parts 5202, detection pattern setting parts 5203, and talk type setting parts 5204. Here, the type of statement refers to whether a statement is a questioning statement, in which one party asks a question to the other party, or a non-questioning statement, which is other talk. Note that whether a certain statement is a questioning statement or a non-questioning statement can be determined by using existing technologies.

In the example shown in FIG. 13, the matching count setting part 5201 shows “1,” the speaker setting part 5202-1 shows “operator,” the detection pattern setting parts 5203-1 shows “◯◯ service,” and the talk type setting part 5204-1 shows “questioning statement.” This means that, if the operator says a questioning statement that includes “◯◯ service” once during a telephone call, “◯◯ service” is detected as a word of interest.

Similarly, in the example shown in FIG. 13, the matching count setting part 5201 shows “1,” the speaker setting part 5202-2 shows “customer,” the detection pattern setting part 5203-2 shows “XX service,” and the talk type setting part 5204-2 shows “non-questioning statement.” This means that, if the customer says a non-questioning statement that includes “XX service” once during a telephone call, “XX service” is detected as a word of interest.

By this means, a word of interest that is set in the detection pattern setting part is prevented from being detected in types of talk other than those that are subject to word-of-interest detection. For example, the example shown in FIG. 13 may be arranged such that “XX service” is not detected as a word of interest if the operator says it in a non-questioning statement. Therefore, for example, settings can be arranged such that a word that is frequently used in non-questioning statements but is used rarely in questioning statements is detected as a word of interest.

### <<Variation 4>>

In the above embodiment, the number of matchings is set in the matching count setting part. However, for example, the number of matchings may be calculated per word of interest, based on the same word used in the past, by using an existing verification technology. In the following description, the telephone call history information that is stored in the telephone call history information DB 107 will be referred to as “past telephone calls” for ease of explanation.

To be more specific, let w be a certain word of interest, μ_{w} be the average number of occurrences of the word of interest w in past telephone calls, and ow be the standard deviation. Also, let μ_{w}+2σ_{w} be the number of matchings. However, this is just an example, and, for example, μ_{w}+3σ_{w} or the like may be used as the number of matchings.

### <<Variation 5>>

In the above embodiment, a word of interest is detected based on whether or not it matches a detection pattern set in the detection pattern setting part. However, for example, it is also possible to detect a word by taking into account words that occur before the word that matches a detection pattern. By this means, it is possible to detect a word of interest more accurately by taking into account the flow and the context of talk up until then, rather than based simply on whether or not the word matches a detection pattern.

To be more specific, after the following pre-processing is performed, the following detection process may be performed in step S201 of FIG. 5, so that a word matching a detection pattern, including nearby words, can be detected as a word of interest. Note that, in the following description, wₓ is a word that is represented by a detection pattern, and i is a past telephone call.

### (Pre-Processing)

(1-1)

From a past telephone call i, a statement S_{i,k} including wₓ, and N statements S_{i,k-1}, S_{i,k-2}, . . . , S_{i,k-N} (where N is a predetermined integer of 1 or greater) that precede statement S_{i,k} are obtained. These statements are grouped together as Dᵢ={S_{i,k}, S_{i,k-1}, S_{i,k-2}, . . . , S_{i,k-N}}. The same is done for each past telephone call, which gives {Dᵢ|i=i₁, i₂, . . . }.

(1-2)

For each Dᵢ (i=i₁, i₂, . . . ), a vector Vᵢ (i=i₁, i₂, . . . ) is calculated by applying an existing technology such as Doc2Vec.

(1-3)

An average vector Vₐᵥₑ of vectors Vᵢ (i=i₁, i₂, . . . ) is calculated.

### (Detection Process)

(2-1)

r is the current telephone call. When a statement S_{r,k} including wₓ is detected, N statements S_{r,k-1}, S_{r,k-2}, . . . , S_{r,k-N} that precede statement S_{r,k} are obtained. Then, these statements may be grouped together as Dᵣ={S_{r,k}, S_{r,k-1}, S_{r,k-2}, . . . , S_{r,k-N}}.

(2-2)

For example, a vector Vᵣ is calculated by applying an existing technology such as Doc2Vec to Dᵣ.

(2-3)

The similarity sim (for example, the cosine similarity) between the average vector Vₐᵥₑ and the vector Vᵣ is calculated.

(2-4)

If the similarity sim is greater than a predetermined threshold (for example, 0.7), wₓ is detected as a word of interest; otherwise, it is not detected as a word of interest.

Note that, despite (2-4) above in which the number of matchings is not taken into account (or in which the number of matchings is set to 1), the number of matchings may be taken into account. In this case, if the similarity sim is greater than a predetermined threshold, wₓ may be determined as finding a match.

### <<Variation 6>>

In the above embodiment, words of interest were detected on a real-time basis, in step S201 of FIG. 5. However, if the service assisting screen display ON/OFF setting part 1007 and the operator assisting screen display ON/OFF setting part 1008 are set to turn off the display, it is not necessary to detect words of interest on a real-time basis. In this case, for example, words of interest may be detected at any timing (for example, at a timing after a telephone call ends, a timing when telephone call history information is searched, etc.).

The present invention is by no means limited to the embodiment described in detail herein, and a variety of alterations and changes, and combinations with existing techniques, and so forth are possible without departing from the scope of the claims attached herewith.

### REFERENCE SIGNS LIST

1 contact center system
10 word-of-interest detection device
20 operator terminal
30 supervisor terminal
40 PBX
50 customer terminal
60 communication network
101 word-of-interest registration part
102 speech recognition text conversion part
103 word-of-interest detection part
104 display information providing part
105 search part
106 registration information DB
107 telephone call history information DB
E contact center environment

1. A detection device comprising:
a processor; and
a memory having instructions stored thereon that, when executed by the processor, cause the processor to:
detect a word of interest from a speech recognition result of a dialogue, wherein the dialogue is between a plurality of parties, the detecting a word of interest is based on a detection condition for the word of interest, and the word of interest comprises at least one of a term, a word, an expression, a phrase, or a sentence that is to be noticed or paid attention to at least by a party of the plurality of parties; and
transmit, based on the detected word of interest, display information to a predetermined terminal, wherein the display information specifies a pre-registered display mode to display at least either one of the detected word of interest or a display component representing the detected word of interest.

2. The detection device according to claim 1,
wherein the detection condition comprises a detection pattern and a predetermined number of occurrences of the detection pattern in the speech recognition result, the detection pattern represents at least either one of a regular expression of the word of interest to be detected or a character sequence representing the word of interest to be detected, and
wherein the instructions when executed by the processor further cause the processor to detect the word of interest based on a number of times the detection pattern occurs in the speech recognition result and the predetermined number of occurrences of the detection pattern.

3. The detection device according to claim 2,
wherein the detection condition further comprises at least either one of a scene in which the detection pattern is spoken, or a type of statement in which the detection pattern is spoken, and
wherein the instructions when executed by the processor further cause the processor to detect the word of interest based on matching a scene or a type of statement in which the detection pattern occurs in the speech recognition result and the scene or the type of statement set in the detection condition.

4. The detection device according to claim 2, wherein the instructions when executed by the processor further cause the processor to determine the predetermined number of occurrences of the detection pattern based on a distribution of occurrences of the detection pattern in past dialogues.

5. The detection device according to claim 2, wherein the instructions when executed by the processor further cause the processor to detect the word of interest based on context of the dialogue from a beginning of the speech recognition result of the dialogue to a part of the speech recognition result where the detection pattern occurs.

6. The detection device according to claim 1, wherein the instructions when executed by the processor further cause the processor to transmit the display information to a first terminal used by a predetermined one speaker of a party of the plurality of parties in the dialogue, and the display information specifies a pre-registered color as an emphasis to display the detected word of interest.

7. The detection device according to claim 6, wherein the instructions when executed by the processor further cause the processor to transmit the display information to a second terminal that is used by a person monitoring and assisting the predetermined one speaker, the display information being for displaying the display component with emphasis in a pre-registered color.

8. The detection device according to claim 7, wherein the the instructions when executed by the processor further cause the processor to transmit, based on detecting the word of interest, information to the second terminal, the information indicates detection of the word of interest to the second terminal by using a pre-registered sound.

9. The detection device according to claim 1, wherein the instructions when executed by the processor further cause the processor to:
search for dialogue history information by using the word of interest as a search condition, in a database, wherein the database stores dialogue history information that represents speech recognition results of past dialogues; and
transmit the display information to a third terminal that specifies the search condition, wherein the display information comprises:
dialogue history information that is obtained from the search, and
the word of interest included in a speech recognition result represented by the dialogue history information obtained from the search.

10. A detection method that causes a computer to:
detect a word of interest from a speech recognition result of a dialogue, wherein the dialogue is between a plurality of parties, the detecting a word of interest is based on a detection condition for the word of interest, and the word of interest comprises at least one of a term, a word, an expression, a phrase, or a sentence that is to be noticed or paid attention to at least by a party of the plurality of the parties; and
transmit, based on the detected word of interest, display information to a predetermined terminal, wherein the display information specifies a pre-registered display mode to display at least either one of the detected word of interest or a display component representing the detected word of interest.

11. A non-transitory recording medium storing a program that, when executed on a computer, causes the computer to perform the detection method of claim 10.
